(19) United States
(12) Patent Application Publication
(10) Pub. No.: US 2014/0353063 A1
(43) Pub. Date: Dec. 4, 2014

(54) LIGHTWEIGHT MULTIPURPOSE VEHICLE

(71) Applicant: Amar Mandalapu, Bethlehem, PA (US)

(72) Inventor: Sai Aditya Mandalapu, Bethlehem, PA (US)

(21) Appl. No.: 13/938,228

(22) Filed: Jul. 9, 2013

(30) Foreign Application Priority Data
Jun. 4, 2013 (IN) 2441/CHE/2013

(51) Int. Cl. B60K 6/22

(52) U.S. Cl. CPC B60K 6/22; Y10S 903/904
USPC 180/271; 180/65.21; 903/904

(57) ABSTRACT

The present invention relates to a lightweight multipurpose vehicle, wherein the lightweight multipurpose vehicle further comprises an engine run by petrol and natural gas, a three phase or a single phase electric induction motor sourced from batteries, paddles, inverters and a switch that allows the driver to drive the lightweight multipurpose vehicle by using at least one of an engine, or a three phase or a single phase electric induction motor powered by batteries or by paddles that have chains to transfer energy from the pedal to rear wheel, so as to rotate the rear wheel, to move the lightweight multipurpose vehicle of the present invention. The lightweight multipurpose vehicle of the present invention also generates electricity sufficient to power all electrical/electronic devices in house.

### PRIORITY CLAIM

This application the benefit under 35 U.S.C. §119 (b) of an application entitled “A lightweight multipurpose vehicle” filed with Indian Patent Office Chennai on Jun. 4, 2013 and assigned an application No. 2441/CHE/2013, the entirety of which is expressly incorporated herein by reference.

### TECHNICAL FIELD OF THE INVENTION

The present invention relates to a lightweight multipurpose vehicle that allows the user to drive the lightweight multipurpose vehicle even when the batteries required for driving the vehicle drain out or when the petrol and natural gas required for powering the engine is unavailable. Also the lightweight multipurpose vehicle of the present invention is capable of generating electricity when the lightweight multipurpose vehicle is in a standby mode.

### BACKGROUND OF THE INVENTION

Generally vehicles are driven by engines which run on fuels such as petrol, diesel, lead replacement petrol, kerosene, natural gas, coal gas, producer gas, biogas, landfill gas, compressed natural gas, bio fuels etc or AC motors powered by batteries. During natural calamities, such as, earthquakes, hurricane, flood, cyclone, volcanic eruptions, storm or during camping, when the fuel for powering the engine is unavailable or even when the batteries in the vehicle drain out; it is not possible for the driver to drive the vehicle either by using an engine or by using an AC motor.

Hence, there exists a need for an improved vehicle that provides the driver with various options for driving the vehicle even when the batteries in the vehicle drain out, or when the fuel required to power the engine is unavailable due to natural calamities such as hurricane, storm etc.

In order to power any electrical/electronic device in a house or to provide power inside a house, generally power is derived from the vehicles alternator or from vehicle's batteries. But the power so generated from the vehicles is not self-sufficient to power the entire house.

Hence, what is needed is a vehicle that allows the driver to drive the vehicle when the fuel required to power the engine is unavailable, or even when the batteries in the vehicle drain out. Also, the vehicle should be capable of generating electricity sufficient to power the entire house.

### SUMMARY OF THE INVENTION

The present invention provides a lightweight multipurpose vehicle comprising an engine run by any fuel, a three phase or a single phase electric induction motor sourced from batteries, paddles, inverters and a switch that allows the driver to drive the lightweight multipurpose vehicle by at least one of an engine run by any fuel, or a three phase or a single phase electric induction motor powered by batteries or by paddles that have chains to transfer energy from the pedal to rear wheel, so as to rotate the rear wheel to move the lightweight multipurpose vehicle.

Thus, the lightweight multipurpose vehicle of the present invention allows the driver to drive the lightweight multipurpose vehicle using paddles, even when the batteries drain out, or even when the fuel required to power the engine is unavailable.

The present invention also provides a mechanism for generating electricity from the lightweight multipurpose vehicle to power any electrical/electronic device, when the lightweight multipurpose vehicle is in standby mode, by coupling the engine with an induction motor using a clutch lever diaphragm or by generating electricity from batteries present in the lightweight multipurpose vehicle through inverter. Also the electricity generated from the lightweight multipurpose vehicle using the above mechanism is self sufficient to power all the electrical/electronic devices in the entire house.

It is to be understood that both the foregoing general description and the following details description are exemplary and explanatory and are intended to provide further explanation of the invention as claimed.

### BRIEF DESCRIPTION OF THE DRAWINGS

The foregoing and other features of embodiments will become more apparent from the following detailed description of embodiments when read in conjunction with the accompanying drawings. In the drawings, like reference numerals refer to like elements.

FIG. 1 illustrates the lightweight multipurpose vehicle in accordance with one or more embodiment of the present invention.

FIG. 2 illustrates a method for generating electricity from the lightweight multipurpose vehicle in accordance with one or more embodiment of the present invention.

### DETAILED DESCRIPTION OF THE INVENTION

Reference will now be made in detail to the description of the present subject matter, one or more examples of which are shown in figures. Each example is provided to explain the subject matter and not a limitation. Various changes and modifications obvious to one skilled in the art to which the invention pertains are deemed to be within the spirit, scope and contemplation of the invention.

The term ‘stand by’ used herein refers to the state of a vehicle when the vehicle is not operational or running and is in idle condition.

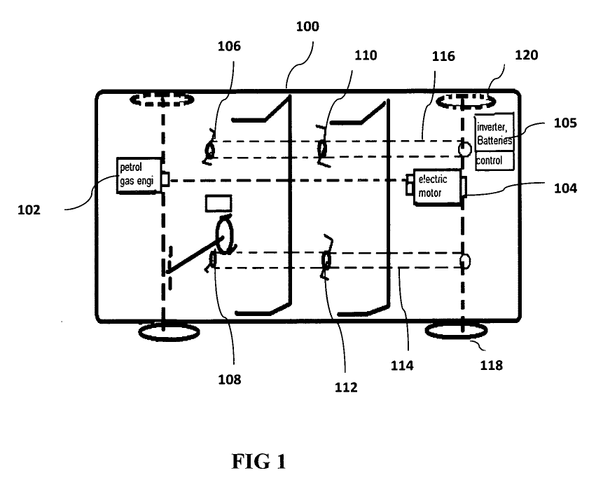

FIG. 1 illustrates the lightweight multipurpose vehicle in accordance with one or more embodiment of the present invention. The lightweight multipurpose vehicle (100) of the present invention comprises an engine (102), wherein the engine (102) is powered by any fuel such as petrol, diesel, lead replacement petrol, kerosene, natural gas, coal gas, producer gas, biogas, landfill gas, compressed natural gas, bio fuels etc, a three phase or a single phase electric induction motor (104) powered by batteries (105), paddles (106, 108, 110, 112) that has chains (114, 116) to transfer energy from the pedal to rear wheel (118, 120) to rotate the rear wheel, so as to move the lightweight multipurpose vehicle (100). The lightweight multipurpose vehicle (100) of the present invention also comprises a switch that allows the driver to drive the lightweight multipurpose vehicle by at least one of an engine (102) or a three phase or a single phase electric induction motor (104) powered by batteries (105), or paddles (106, 108, 110, 112) that have chains (114, 116) to transfer energy from the pedal to rear wheel, so as to rotate the rear wheel to move the lightweight multipurpose vehicle (100). Thus the lightweight multipurpose vehicle (100) of the present invention allows the driver to drive the lightweight multipurpose vehicle using paddles (106, 108, 110, 112) even when the batteries (105) drain out, or when the fuel required to power the engine (102) is unavailable during natural calamities, such as, earthquakes, hurricane, flood, cyclone, volcanic eruptions, storm or during camping.

The lightweight multipurpose vehicle (100) of the present invention comprises a distance sensor to measure the distance of the rear and front vehicle approaching the lightweight multipurpose vehicle (100). The lightweight multipurpose vehicle (100) further comprises a microprocessor for reading the distance of the rear and front vehicle from the distance sensors and displaying the approaching vehicle speed at the rear and front end of the lightweight multipurpose vehicle (100) using a LCD display device so as to provide caution to the approaching vehicle. Here, the microprocessor converts the distance of the rear and front vehicle, read from the distance sensors to speed, in reference to the lightweight multipurpose vehicle at real time so as to calculate the approaching vehicle speed.

In accordance to one embodiment of the present invention, the lightweight multipurpose vehicle (100) comprises customized smaller sized engine (102), three phase or a single phase electric induction motor (104), batteries (105) so that the overall weight of the lightweight multipurpose vehicle (100) is reduced thereby enabling the passengers to drive the lightweight multipurpose vehicle (100) by using paddles (106, 108, 110, 112).

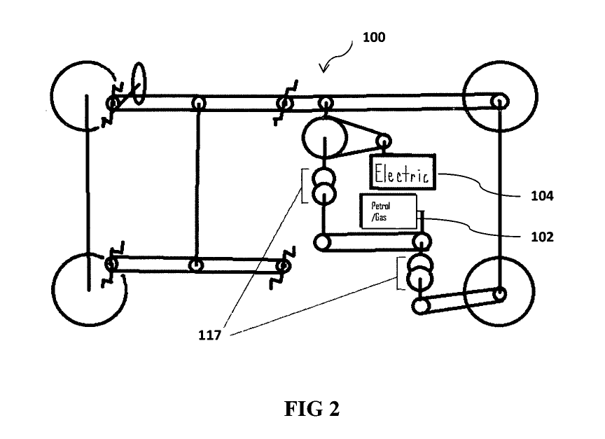

FIG. 2 illustrates a method for generating electricity from the lightweight multipurpose vehicle in accordance with one or more embodiment of the present invention. The lightweight multipurpose vehicle (100) of the present invention is also used for generating electricity by coupling the engine (102) with the three phase or a single phase electric induction motor (104) using a clutch lever diaphragm, or generating electricity from batteries (105) through inverter (105a). Here, the inverter (105a) is used to convert the direct current from the batteries (105) in the lightweight multipurpose vehicle (105) to alternating current so as to power any electrical/electronic device in the house.

The clutch (117) is used to couple the engine (102) with a three phase or a single phase electric induction motor (104) so as to run the three phase or a single phase electric induction motor (104) as a generator.

In accordance with one or more embodiment of the present invention, the engine (102) can be coupled with the three phase or a single phase electric induction motor (104) using any coupling mechanism such as double pulley mechanism.

The lightweight multipurpose vehicle (100) of the present invention generates electricity sufficient to power the entire house. For this purpose, the engine (102) has a power capacity of 5 HP and the three phase or a single phase electric induction motor (104) has a power capacity of 20 HP. So that when the engine having a power capacity of 5 HP with rated RPM 1500 is coupled with the three phase or a single phase electric induction motor (104) having a power capacity of 20 HP driven at RPM 1700 by using any coupling mechanism, the single phase electric induction motor (104) acts as a generator and generates 3 kilowatts of electricity to power the entire house.

It is to be understood, however, that even though numerous characteristics and advantages of the present invention have been set forth in the foregoing description, together with details of the structure and function of the invention, the disclosure is illustrative only. Changes may be made in the details, especially in matters of shape, size, and arrangement of parts within the principles of the invention to the full extent indicated by the broad general meaning of the terms in which the appended claims are expressed.

I claim:

1. A lightweight multipurpose vehicle comprising an engine, induction motor sourced from batteries, paddles, inverters and a switch that allows the driver to drive the lightweight multipurpose vehicle by at least one of:
a. an engine; or
b. an induction motor powered by batteries; or
c. paddles that have chains to transfer energy from the pedal to rear wheel, so as to rotate the rear wheel to move the lightweight multipurpose vehicle.

2. The lightweight multipurpose vehicle as claimed in claim 1, wherein the engine is run by any fuel such as petrol, diesel, lead replacement petrol, kerosene, natural gas, coal gas, producer gas, biogas, landfill gas, compressed natural gas or bio fuels.

3. The lightweight multipurpose vehicle as claimed in claim 1, wherein the induction motor is a three phase or a single phase electric induction motor.

4. The lightweight multipurpose vehicle as claimed in claim 1, wherein the lightweight multipurpose vehicle allows the driver to drive the lightweight multipurpose vehicle using paddles even when the batteries drain out, or when the fuel required to power the engine is unavailable.

5. The lightweight multipurpose vehicle as claimed in claim 1, wherein the lightweight multipurpose vehicle further comprises:
a) a distance sensor to measure the distance of the rear and front vehicle approaching the lightweight multipurpose vehicle;
b) a microprocessor for:
measuring the speed of the lightweight multipurpose vehicle;
reading the distance of the rear and front vehicle approaching the lightweight vehicle;
converting the distance of the rear and front vehicle to the speed in reference to the lightweight multipurpose vehicle at real time; and
displaying the approaching vehicle speed at the rear and front end of the lightweight multipurpose vehicle using a LCD display device so as to provide caution to the approaching vehicle.

6. A method for generating electricity from lightweight multipurpose vehicle to power any electrical/electronic device, the method comprising the step of coupling an engine with an induction motor using a clutch lever diaphragm wherein the lightweight multipurpose vehicle is in standby mode.

7. The method as claimed in claim 6, wherein the lightweight multipurpose vehicle generates electricity sufficient to power all electrical/electronic devices in the house.

8. A method for generating electricity from lightweight multipurpose vehicle to power any electrical/electronic device, the method comprising the step of generating electricity from batteries through inverter wherein the lightweight multipurpose vehicle is in standby mode.

9. The method as claimed in claim 8 wherein the lightweight multipurpose vehicle generates electricity sufficient to power all electrical/electronic devices in the house.
